(19) United States
(12) Patent Application Publication
(10) Pub. No.: US 2022/0374391 A1
(43) Pub. Date: Nov. 24, 2022

(54) INFORMATION MANAGEMENT SYSTEM

(71) Applicant: THE MILLENNIUM GROUP OF DELAWARE, INC., Tinton Falls, NJ (US)

(72) Inventor: Christopher Fahey, Denton, MD (US)

(21) Appl. No.: 17/749,417

(22) Filed: May 20, 2022

Related U.S. Application Data
(60) Provisional application No. 63/191,059, filed on May 20, 2021.

(51) Int. Cl. G06F 16/11

(52) U.S. Cl. CPC G06F 16/119

(57) ABSTRACT

One embodiment is an information management system which is capable of routing and/or delivering the information to a user. The system can include a notification system for providing a notification to the user associated with the information.

### CROSS-REFERENCE TO RELATED APPLICATION

This application claims priority to US Provisional Application No. 63/191,059, filed May 20, 2021, which is incorporated by reference herein in its entirety.

### BACKGROUND

Processing information can be a difficult task. In the case of physical documents, such as mail, the quantity of documents and the number of individuals needed to handle the processing, for example, can be prohibitive. It can be difficult to not only transform the physical documents into a digital format, but also to determine who the digital item is intended for and how to get it to that person.

What is needed is a system that can automate and digitize much of the processing. This would enable information management to become a practical task that is capable of being achieved, in cases of large quantities of physical information, such as mail.

### BRIEF DESCRIPTION OF THE DRAWINGS

FIG. 1 is a diagram of an instrument management system according to one embodiment.

FIG. 2 is a diagram of an instrument management system according to another embodiment.

FIG. 3 is a flowchart that illustrates the operation of address matching according to one embodiment of an instrument management system.

FIG. 4 is a flowchart that illustrates the operation of address matching according to another embodiment of an instrument management system.

FIG. 5 is a flowchart that illustrates the operation of a matching and fitting process according to one embodiment of an instrument management system.

FIG. 6 is a flowchart that illustrates the operation of text categorization according to one embodiment of an instrument management system.

FIG. 7 is a flowchart that illustrates the operation of one embodiment of an instrument management system.

### SUMMARY OF THE INVENTION

One embodiment is an information management system, which comprises a first system for transforming the information into a digital form, a second system for receiving the information from the first system, the second system comprising, a service system for receiving the information and storing it in a storage medium, an assignment system for accessing the information from the medium and assigning it to a user based on one or more rules, a routing system for delivering the information to the user, and a notification system for providing a notification to the user associated with the information.

Another embodiment is a method, which includes transforming information from a physical form to a digital form, receiving the information at a computing device, storing the information in a database, applying one or more rules to the database to assign the information to a user, providing a notification to the user associated with the information, receiving via a web browser a request to access the information, and determining if the request to access can be granted, and if so providing the information to the user.

Another embodiment is a device, including a transformation module configured to transform information from a physical form to a digital form, a receiving module configured to receive the information at a computing device and store the information in a database, an assignment module configured to use the database to assign the information to a user, a notification module configured to provide a notification to the user associated with the information, and an access control module configured to receive via a web browser a request to access the information, wherein when the access control module can grant the request, the information is provided to the user.

### DETAILED DESCRIPTION OF THE INVENTION

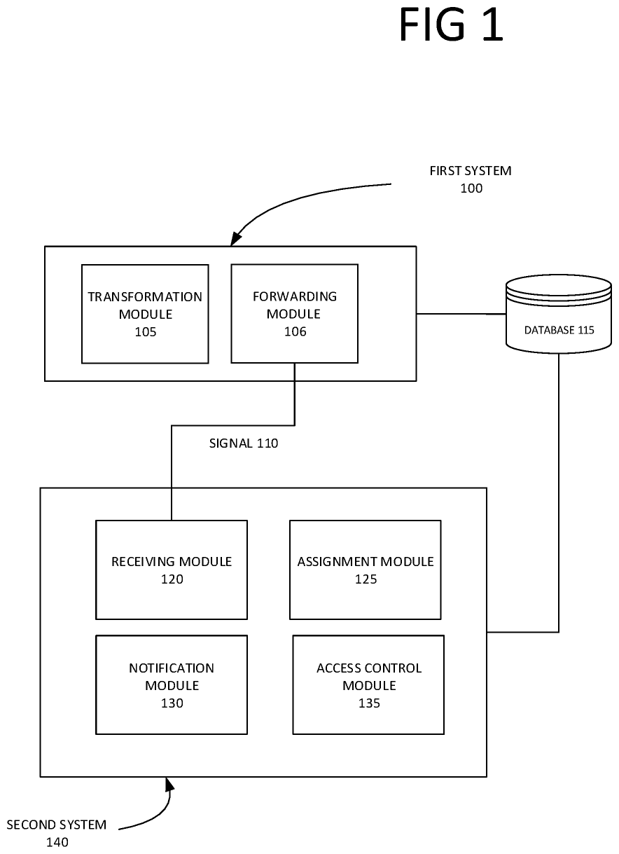

FIG. 1 illustrates an example information management system. In one embodiment, a first system 100 and a second system 140 include of multiple integrated applications that provide user access to physical postal mail in a digitally scanned format. Images can originate on an enterprise-scale, image scanner, within a transformation module 105, for example.

A forwarding module 106 receives the images and can send them over a network to the second system 140, which in one embodiment is an image processing server. A receiving module 120 receives the images from the forwarding module 106 where they are stored and processed for address information and text. Mail images are then assigned to employees by an assignment module 125. The assignment module 125 can be automated or it can be used manually by a mail manager using a manager workstation (not shown).

The resulting pieces of mail are then accessed by users via an access control module 135. In one example this includes using the internet and an available web server. A notification module 130 can also be used to notify the users that mail has been assigned to them.

In operation, images can be captured and can be processed by the plurality of standards-based applications in the first and second systems 100 and 140 using a database 115. For example, the forwarding module 106 can send images to a service application that stores the images in the database 115. A secondary application can perform OCR on the scanned images subsequently combining them into logical mail pieces and assigning them to employees registered with the assignment module 125. The assigned pieces of mail can then be routed to users, which can include using rules setup by the users to determine how the routing should occur. Subsequently, email notifications can be sent out by the notification module 130 to the users that have been assigned to receive the mail.

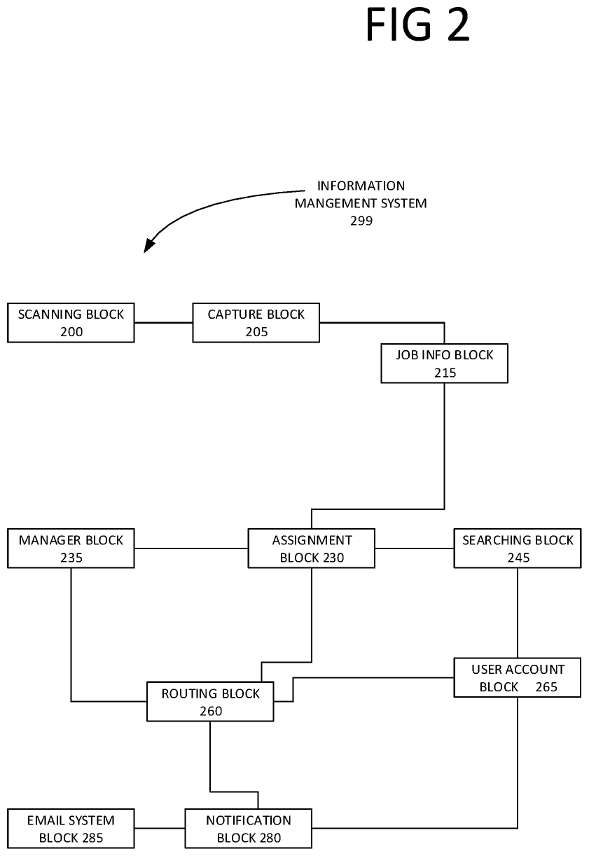

FIG. 2 illustrates an example information management system 299 according to another embodiment of the invention. According to the embodiment described in system 299, all mail image files start out as images produced by a scanning block 200 in the form of a job. A job can be a unique transaction that consists of a nonspecific starting and ending letter and may entail one or more batches. A batch can be a subgroup of a job and is used primarily to partition the units of information, or mail, to facilitate easier access to the mail if a physical copy is requested. A job does not require a unique physical marker. In one embodiment, every batch has a unique physical marker. The physical marker can include a batch sheet that contains a unique identifier that cannot be duplicated randomly and is specific to the company the identifier is generated for.

In one example, all identifiers in the system 299, including database primary and foreign keys, are created using a UUID, in order to prevent primary key collisions from occurring during the exchange of database records. A UUID, or Universally Unique Identifier, is a standard used in software standardized by the Open Software Foundation as part of the Distributed Computing Environment (DCE). It consists of a 16-byte number written in hexadecimal and is theoretically guaranteed to be unique universally.

Within a job, a batch consists of a batch page, printed using image forwarding software, for example on an image forwarding PC. The contents of the mail, the envelope the mail was received in, and optionally a separator sheet are obtained in capture block 205. The separator sheet can be used to mark the boundary between pieces of mail. It is optional if the scanner can indicate which file contains the image of the envelope. The envelope position can be either precede the letter content or trail it.

The image forwarding software relies upon the scanning block 200 to create a trigger file that indicates a job is ready for processing. If this file is XML based, the image forwarding software can read it to understand what the images are and negate the need for separator sheets in the job. In any case, the creation of trigger file is used as an event to start forwarding the images of a job to a mail server application on a processing server. In one example this information is stored in job info block 215.

When starting a job, the image forwarding software contacts the server and requests a job id. The server records this transaction in the database and returns the identifier to the image forwarding software. Each image forwarded within this job is associated with the job id assigned by the mail server in block 215. If the image forwarding software has an XML file that indicates the content of each image, that information is relayed to the server at the instant the image is copied to the server. Once all of the images within the job have been copied to the server, the job is closed and marked for processing in block 215.

Processing of the images can be performed by an assignment block 230, or assignment application used herein interchangeably. The assignment block 230 takes what information is contained in the database (not shown) regarding the image and can perform an OCR on them. All OCR text results are placed in the database in a logical structure that allows for a rudimentary reproduction of the original document. If the scanning block 200 was unable to produce any information regarding the content of the images, then the assignment block 230 must process each image.

The first task the assignment block 230 performs is to look for the batch page within the image job. A batch id found on the batch page can be used to identify the company the batch is for. Configuration of the system indicates the position of the envelopes and whether separator sheets are being used. If separator sheets are used, then markers can be searched for on each page while looking for separator sheets. Additionally, each page can be checked to see if it is a batch page. In one embodiment, batch and separator pages contain a set of characters located in the upper left corner of a standard sheet of paper. The combination of the characters with the location provides a reasonable assurance against a random duplication.

As the images are processed, the identification of envelope images and subsequent address identification on the envelope is performed. Depending on the sophistication of the scanner, the assignment block 230 either has the letter images predefined for it with the indication of the location of the envelopes or it can discover the letter images by locating the separator sheets manually. The location of the address on the envelope is assumed to conform to postal standards but some leeway is given down and to the right for the sender's address. The receiver's address can be a company address as loaded in the database for which the batch id was generated and typically does not extend more than 2/3 of the way up the image. If not, it can be assumed to be a sender address, if and only if, it is the left and upper most address on the page. If a receiver address is not found on the envelope, either through the fault of misconfiguration in the database, poor OCR results or a windowed envelope, the content of the letter is checked for the address at manager block 235.

Starting with the first page of the letter, all blocks of text with 10 lines or less are examined for an address. Matching starts at the bottom of the first page, proceeding to the top of the page before the next matching attempt is performed on the next page. If an address is found that matches a company address for the batch the letter is within, that address is taken as the receiver's address.

Using the sender addresses, the assignment block 230 tries to match the text against previous sender's names stored in the database using searching block 245. To achieve this, the address can be parsed to isolate the address from the names. Using the name, a soundex can be created and used to retrieve any previously recorded senders that have a name within a predetermined range of the soundex in user account block 265. The address is also used to narrow the results. Once a set of names has been returned, a string similarity algorithm can be used to further reduce the result set and the resulting sender record is associated with the letter in user account block 265. If the sender lookup does not return a valid result, a new sender record is created and associated with the letter. The process of using the soundex and string similarity algorithm to locate names in the database is described hereinafter with reference to “Name Matching.”

Matching the receiver to an employee name can be performed in the same manner. A soundex can be created to retrieve a potential list of matching names then an edit-distance is used to further eliminate wrong answers. When looking for possible name matches, department names must also be examined. Employee names can take precedence over department names even when the matches are equal. Once an employee name is found that clearly matches the text for the receiver, the employee id is assigned to the letter. If the process does not yield a clear decision between two or more records or no matches at all are found, no employee id is assigned to the letter that indicates it needs to be manually routed in routing block 260.

Once the images that make up a piece of mail have been identified and sender and receivers have been located, an assignment record is created that identifies the group of images as a logical piece of mail and includes references to sender and employee records as the sender and recipient. At this point, the mail record can be in one of three possible states. The first is it is unassigned and needs to be manually assigned. In other words, the assignment block 230 was unable to accurately determine which employee the mail was addressed to. The second state is the mail could exist in is as assigned but not routable. The system can be configured to immediately route all automatically assigned mail or not. If not, or if mail has been manually assigned, then the mail remains queued until a user releases it to be routed. By default, the system 299 can be set to route automatically. The last state the mail can exist in is assigned and released for routing. In one example, the system is running as a service bureau. In this embodiment, an exchange of database records and mail images take place.

Once the mail has been assigned to an employee and marked for routing via one or more of the routing block 260 and/or the user account block 265, the mail can be made available to the employee. In most cases, the routing block 260 routes the information to the employee the mail is assigned to. To do this, it takes the assignment record and creates a mail record from it that is associated with the employee's account at block 265. In some cases, however, the employee has designated that a copy of the mail is to be routed to another employee. In this case, the application associates the mail record with the other employee. At this point, the employee has access to the images that make up the mail.

When the routing block 260 or another component of the system creates a new mail record, it can mark it as new, and it is the responsibility of the notification block 280 to examine the database looking for these new mail records. In one example, the notification block 280 continually pings the database to query for new mail records. In other embodiments, the notification block 280 pings the database periodically or on some other cadence. If the notification block 280 discovers information that has not been marked as notified, then the notification block 280 looks up the email address of the employee associated with the mail using email system block 285. In one example, the notification block 280 sends an email notification indicating a new piece of mail has arrived.

Two types of notifications are used in different embodiments using notification block 280. One example is a daily notification, and another example is a piece-wise notification. To send either type of notification, the notification block 280 retrieves a template from the database and/or email system block 285, that corresponds to the type of email the employee wishes to receive regarding their mail. This template can be created by an administrator and contains text and instructions for the application on what information from the database is to be used. Once the email has been constructed, it is sent using the email server the system was configured to use in email system block 285. If an image is to be displayed in the email, the image itself does not need to be sent. Instead, a link can be included that is displayed by the email client.

Users, administrators, and managers can access the system using a web browser running a flash-based client application that communicates with the application server. Other means to access the system are possible as well according to various embodiments of the invention. The application server has the necessary access to the database to perform the operations required to maintain the system, administer information, administer the system, assign mail, route mail, or access employee mail. In one example, the user logs in with a username and a password that is created for them by the system. The system can import these records into the system, or a new account can be created manually. In one embodiment, an administrator can create the new account and in another it can be created through a request by the user from a login screen.

The system can be installed in three different configurations, enterprise, client, or server. In the enterprise configuration, all services and applications are colocated and a single database can be used. When deployed using a client/server configuration, the applications are separated depending on the role of that system. Image forwarding, processing and mail assignment can take place on the system used by the server, whereas mail routing and notification can take place on the system used by the client. A purge and synchronization operation can take place to exchange images and database records. This operation can be accomplished using file encryption and secure FTP tied to exchange accounts registered with the system. Only the service side has an FTP server running. All clients have the necessary login information and send and pull the exchange records.

A forwarding module, such as module 106 of FIG. 1 is now discussed in more detail. The forwarding module 106 can include, for example, image forwarding software which can be windows based and communicates with mail server services, such as those found in second system 140, using CORBA.

In one example, the CORBA-based service waits for files to be sent to it. Its API allows it to respond to requests to open a new processing job, receive an image file for a processing job, close a processing job, reserve a batch identifier, and provide a list of installed companies. This service works in conjunction with the forwarding module 106 to perform these tasks.

When the forwarding module 106 begins to process a job, it contacts this application and requests a processing job identifier. After validating access based upon the IP address of the requesting client, the application creates a record in the database and returns the unique identifier for the record. As each image is forwarded, the unique identifier is sent with it. As the files are received by the service, they are written to the database which is also updated with the type of image. Once each image has been forwarded and stored by the application, the processing job can be closed and marked as ready for assignment.

Reservation of the batch identifier can take place in conjunction with printing of a batch page. The batch identifier allows the software to group the mail by company and further subdivide them within a processing job. When a batch page is printed, the user can indicate which company the batch page is for. The image forwarding software then can contact the mail service and request a batch identifier for that company. The mail service creates a record in the database that contains a new unique identifier and the company it corresponds with. The unique identifier is then returned to the image forwarding module 106 for use in the batch page.

An assignment module, such as module 125 of FIG. 1 is now discussed in more detail. The assignment module 125 can include process stored images and assign them to employees. The assignment module 125 can take what information is contained in the database regarding the image and perform an OCR on the images. The assignment module 125 can use a Tesseract 4.0 OCR engine for its OCR capability. The application waits until a processing job has been completed before processing it. If the scanner was unable to produce any information regarding the content of the images in the processing job, then the assignment module 125 can process each image to determine its type.

In operation, the assignment module 125 first looks for the batch page within the processing job, which is typically the first page scanned. A batch number found on the batch page can be used to identify the company the processing job is intended for. Additionally, if the scanner is unable to indicate the position of envelopes, then separator sheets can be used. This allows the application to determine the location of the envelopes. Determination of the envelopes determines the group of images that make up a logical piece of mail.

Once the images that make up a piece of mail have been identified, they can be processed as a single entity and an assignment mail record can be created. As the images from the mail are OCR'ed, the resulting text can be placed in the database in conjunction with the image it was taken from.

As the images are processed, one goal is the identification of addresses found in the mail. Addresses found on envelopes can be given priority. Depending on the sophistication of the scanner, the assignment module 125 either has the letter images predefined with an indication of the location of the envelopes or it discovers the letter images by locating the separator sheets. The location of the address on the envelope typically conforms to postal standards, but some leeway can be given, so long as the sender's address textually precedes the receiver's address. The receiver's address is typically a company address as loaded in the database for a company which the batch number was generated for. If a sender or receiver address is not found on the envelope, either through the fault of misconfiguration in the database, poor OCR results, or a windowed envelope, the contents of the letter is checked for addresses.

In one example the process is as follows. Starting with the first page of the letter, all blocks of text with 10 lines or less are examined for an address. Matching starts at the top of the first page, proceeding to the bottom of the page before the next matching attempt is performed on the next page. If an address is found that matches a company address for the batch the letter is within, that address is taken as the receiver's address. If a sender address was not found on the envelope, then those addresses found within the content are potential sender addresses. Preference can be given to those addresses found on the same page as the receiver's address.

Using identified sender and receiver address text blocks, the assignment module 125 tries to match the non-address text against previous senders and employee names stored in the database. To achieve this, the address can be parsed to isolate the address from the non-address text. Using the remaining text, a soundex can be created from the text and used to retrieve any previously recorded senders that have a name with a pre-configured range of the soundex value used. The address can also be used to narrow the results. Once a set of names has been returned, an edit distance algorithm can be used to further reduce the result set and the resulting sender record is associated with the letter. If the sender lookup does not return a valid result, a new sender record can be created and associated with the letter.

Matching the receiver to an employee name can be performed in the same manner. A soundex can be created to retrieve a potential list of matching names then an edit-distance can be used to further eliminate wrong answers. When looking for possible name matches, position, department and company names must also be examined. Employee names can take precedence over position and department names even when the matches are equal. Once an employee name is found that clearly matches the text for the receiver, the employee is assigned to the letter. If the process does not yield a clear decision between two or more records or no matches at all are found, no employee is assigned to the letter. In one embodiment, when no employee is assigned to the letter, it is manually routed.

At this point, a mail record can be in a plurality of states. A first state is unassigned and needs to be manually assigned. In this state, the assignment module 125 was unable to accurately determine which employee the mail was addressed to. A second state is the mail has been assigned, but not routed. Yet another state is, the mail has been assigned and released for routing.

Address Determination and Matching

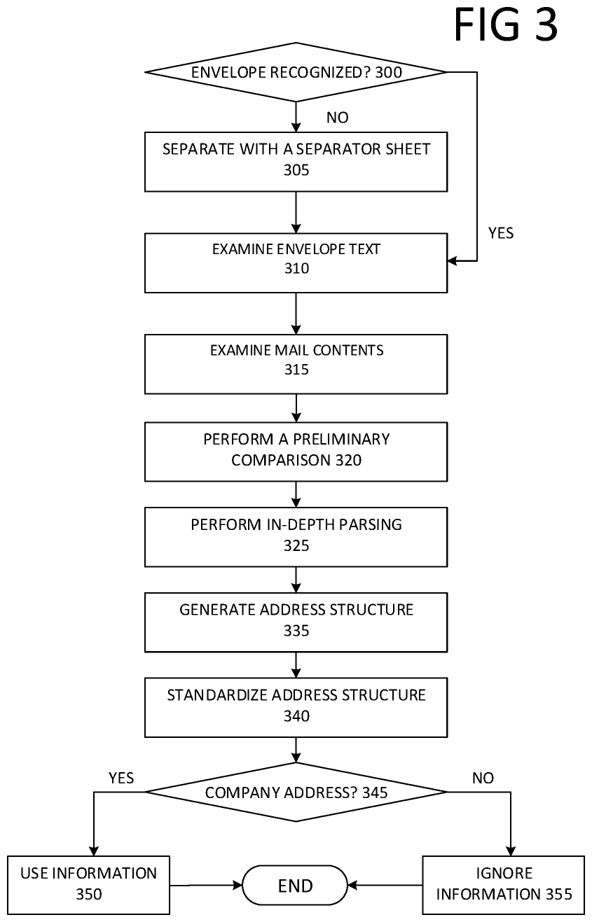

As the first step in isolating employee names, addresses in the letter can be identified, parsed, and compared against a list of existing company addresses. FIG. 3 is a flowchart that illustrates the operation of address matching according to one embodiment. Once these steps have been completed, the remaining elements in the address blocks can be considered part of the recipient text and name matching can take place. The system determines at step 300 whether it can recognize the envelope. If it cannot, then at step 305, then the letters are separated with a separator sheet. To identify address blocks within a piece of mail, the text from the envelope is examined at step 310. Step 310 also occurs in the case where the envelope is recognized at step 300.

Then, to step 320, a preliminary comparison is performed. For example, starting with the envelope, blocks of text that are 10 lines in size can be subjected to the preliminary comparison which looks for the most basic address format. This basic format can consist of a numerical sequence preceded by a word and a 2-letter character string. If the preliminary comparison indicates that it is a possible address block, then the text is subjected to more in-depth parsing and comparison at step 325. The entire text block can be parsed using a myriad of REGEX statements, in one example. Each line is evaluated to determine what component of an address it is using. Both the evaluation of the REGEX statements, as well as the results of processing previous lines can be used. The result of the parsing at block 325, is an address structure that has each element of the address identified at step 335. Once the elements are identified, they are then standardized according to existing postal standards at step 340. The current standards adhered to are the United States Postal Service's Addressing Standards based upon USPS Publication 28 from November 1997.

This embodiment can be designed such manner that as support for other postal standards are required. Using the general API of the parsing classes, it is possible to replace it, so it can parse international addresses. Once an address has been identified and standardized, it is then compared with the list of company addresses within the database at step 345. If the comparison indicates that the address is a company addresses, then this information can be used along with the recipient text from the address to find and match with an employee in the database at step 350. If the address is not a company address, it is either ignored or if it was present on the envelope, it is considered to be the sender address block at step 355.

Name Matching

Prior to any name matching, the system can prepare a list of names that can be used for matching. Each name in the system has the potential for having multiple variations for the same name. All variations can be supplied to the system. Variations include such things as abbreviations for common words such as Dept for Department, Acctng for Accounting, or Svc for Service. Variations for people's names can include such things as nicknames, shortened versions of a first name, a maiden name, and titles. For names such as a mailstop, position, department, or company name, the system uses the variations as alternative spellings when referring to any of these names. However, with people names, a plurality of other variations exist. Personal names can be shortened or lengthened together in a myriad of ways. For instance, Dr. Robert Frost can also be referred to as Dr. Frost or Robert Frost. If this person also is known by Bob, then the number of potential variations doubles. Each of these variations is used to refer to the same employee.

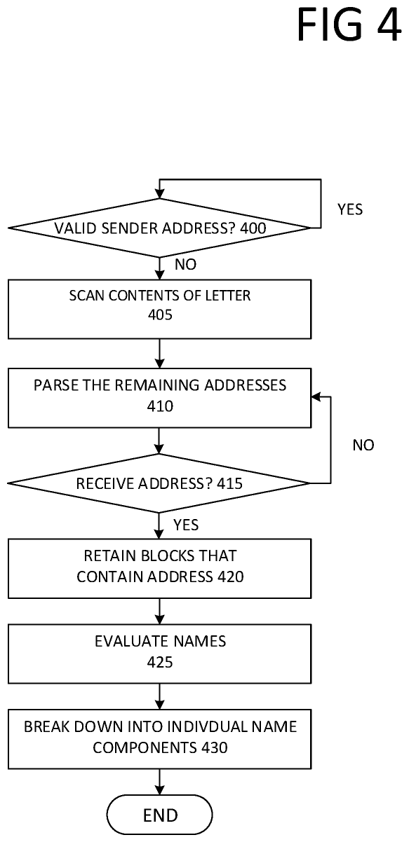

FIG. 4 is a flowchart that illustrates the operation of address matching according to one embodiment of an instrument management system. When the system processes the information looking for names, it starts with the envelope and searches for any blocks of text that contain a valid address at step 400. If none are found on the envelope, it scans the contents of the letter at step 405. In one example, the system can create a list of all that it found and the order that it found them in beginning on the first page. The order of the addresses found can be used to determine which address is the sender's and which are potential recipients.

After resolving which block of text was a sender's address, the system proceeds at step 410 and parses the remaining addresses. At step 415, the system compares the blocks of text against a list of company addresses. If the blocks of text contain recipient's addresses, they are retained at step 420, otherwise step 410 repeats. In general, an envelope should contain two blocks of text that contain an address but if not, the contents of the letter are scanned for addresses and every block of text that matches a company address can be retained as a possible recipient match at step 420.

Once the list of possible addresses and recipients has been collected, the text comprising what should be a name is evaluated at step 425. Recipient text lines can be evaluated to being a person's name, a position, a department name, company name, or a mail stop code. All other forms of internal addresses can be ignored. Each line of text not part of the address can be considered a recipient line and can be broken down into individual name components at step 430.

In one example, to evaluate the recipient text line and come up with a positive match, the text lines are broken up into individual words or tokens. Using these tokens, a search of any name that contains that token is performed. So, for instance, if the token “DR” was considered, then any names that contained the token “DR” would be searched for. Since OCR results are often imprecise, the system can use a soundex calculated using the tokens to filter the tokens of employee, positions, company, and department names. However, even though a soundex can be used, there is a chance the token will not match a soundex of a token from an actual name. Therefore, a soundex range can be used to return possible matches of tokens from names that have soundex values that fall within a specific range. This value is configurable by the system administrator to narrow the results.

After the soundex process has returned at least one token for a name, each token found within the range can then be compared to the soundex token for similarity. A standard Jaro string similarity can be performed between the two, and if the result meets a minimum threshold, the name from which the token came from can be used in a more comprehensive comparison. To operate more efficiently, the system does not consider every potential match. Rather, it can exclude most results by using a minimum threshold. This minimum threshold is called the edit distance range, which can be a configurable value and can specify the minimum value a match must have to be considered a “good” match. If the value meets this minimum, it is retained as one of the exact matches found by the system.

The tokens of the names that meet the minimum threshold are then compared against the recipient text line. This comparison can be performed using a hybrid string, similarity approach for matching. Since there is no one ideal comparison method, combinations of multiple string similarity algorithms are used in conjunction with each other. Collectively these algorithms include looking at the number of tokens, the edit distance, and string length, forwards and backwards, to calculate a number that equates to the difference in the spelling between the two. The hybrid approach splits the emphasis into two parts whereby the token count has the more weight in the result by 10%. The result of this comparison is a normalized number from 0 to 1, but it can also be considered as a percentage of how close the comparison was. 100% can be used as an exact match, whereas 0 can mean no match. Since it is possible that the recipient text line contains more than one name, the result of this comparison can also yield a second number, which is the comparison of the name against a segment of the recipient text line that the token from the name originally matched against.

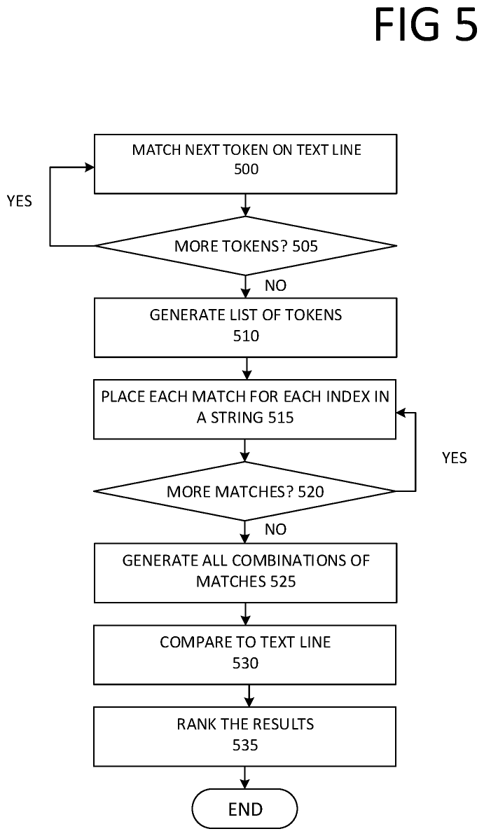

There is no way to know in advance if the recipient text line contains one or more names from within the company. Because of this, a matching and fitting process can be carried out. FIG. 5 is a flowchart that illustrates the operation of a matching and fitting process according to one embodiment of an instrument management system. At step 500, matching takes place on every token found in the recipient text line. This matching is against the remaining tokens from the recipient text lines. Step 505 repeats until all potential matches have been found for all tokens. The result at step 510 is a list of tokens is generated. In one example, matches of names that occur at different locations of the recipient text line are generated, depending on what tokens were found from what names.

Once the list of matching names has been created, all possible matches according to their location, or index is put through a fitting operation at steps 515, 520, 525, 530, and 535. During this operation, each match for each index is placed in a string at step 515 in the order that it occurred when compared against the recipient text line. The process repeats at step 520 until all possible matches for each index have been used creating many combinations of matches at step 525. At step 530 the combinations are compared against the original recipient text line. This can include, for example, using a hybrid string similarity algorithm. Thereafter, at step 535 the results are ranked, and the process ends.

One example of the fitting operation works in the following manner. Using the matching set of names found for each index of the address receiver line, an algorithm moves through each token index and pulls comparison element names that were similar from that position and builds a sequence of matches, filling in after the element name with other similar matches at indexes further into the token string. The algorithm continues until the end of the tokens list or the tokens at the index have been considered for use already.

Give a possible matching string of ABCDEFGHI, example matches at indexes is shown in Table 1:

TABLE 1

| Matching String | Candidate Matches |
|---|---|
| ABCDEFGHI | 0 1 2 3 4 5 6 7 8 |
| ABCDEFGHI | 1 a b c d e |
| ABCDEFGHI | 2 d e |
| ABCDEFGHI | 3 e f g |
| ABCDEFGHI | 4 a b c |
| ABCDEFGHI | 5 d e f g |
| ABCDEFGHI | 6 b c d |
| ABCDEFGHI | 7 c d e f |
| ABCDEFGHI | 8 g h i |
| ABCDEFGHI | 9 f g h i |
| ABCDEFGHI | 10 d e f |

The list by index locations will result in the sets of tokens corresponding to each starting index where the tokens match started. This data is represented in Table 2:

TABLE 2

| Index Location | Token Match |
|---|---|
| 0 | abc \| abcde |
| 1 | bcd |
| 2 | cdef |
| 3 | def \| defg \| de |
| 4 | efg |
| 5 | fghi |
| 6 | ghi |

Parsing the list of index locations will result in matching fits from start to end consuming all tokens each having a fit that starts and ends with the length of the match at that location and the previous matches at those locations. This data is represented in Table 3:

TABLE 3

| Index Location | Matching Fit |
|---|---|
| 1 | abcde, fghi |
| 2 | abc, defg |
| 3 | abc, def, ghi |
| 4 | abc, de, fghi |
| 5 | bcd, efg |
| 6 | cdef, ghi |

Each item in this list is then compare with the original, ABCDEFGHI, for similarity and a percentage can be generated. This percentage is considered the confidence value. It not only contains the overall similarity of the entire string but also of the elements that make up the comparison of the parts. An example of the results would be the list shown with respect to Table 4:

TABLE 4

| Index Location | Confidence Value |
|---|---|
| 1 | 100%, abcde-90%, fghi-90% |
| 2 | 77%, abc-85%, defg-60% |
| 3 | 100%, abc-100%, def-100%, ghi-100% |
| 4 | 100%, abc-95%, de-90%, ghi-100% |
| 5 | 66%, bcd-70%, efg-60% |
| 6 | 77%, cdef-70%, ghi-100% |

In one example, the results can then be ranked. Ranking of these items can include looking at the overall confidence number as well as considering confidence values of the parts, the location of the preferred matches, whether or not the parts that make up the match come from matches from the same type of name (such as two department names), the name was an employee name but one match didn't correspond to the address it was found with (but the other did), or by precedence one was a position while the other was a department name. So, for example, while items 1, 3, and 4 were most similar followed by 2, 6, and then 5 which was the least similar, ranking might result in the 3rd item being the preferred choice even if 2 others were just as similar.

At this point there will either be a single exact match, multiple matches, or no exact matches. If no exact employee matches are found but an exact department was found, the employee designed to receive mail for the department can be used as the match. A single exact employee match is self-explanatory. Likewise, if no exact employee match is found but an exact position match is found, then an employee assigned that position is searched for and if and only one is found, the corresponding employee can be used as the match.

If multiple exact employee matches are found, the system then tries to further refine the match list by evaluating the employee records using any department or mail stop code matches found in the address. Each employee record can be evaluated using the matching department or mail stop code to determine if that employee is a match. If both a matching department and mail stop were in the address, then the employee must be assigned to that corresponding department and mail stop for the employee to be considered a match. The result of this step is either the refinement of the matches to a single employee or left as a multiple exact match.

Text Categorization

Once the address location step has been completed and any senders or employees have been identified with the addresses, but prior to the assignment record being created, the OCR results of the letter can be passed through a text categorization step to identify the category of the mail. One approach is to make each category correspond to a department within the company. However, this is not required, and the categories can equate to any grouping that the company desires. Additionally, categorization does not impose any restrictions on the mail.

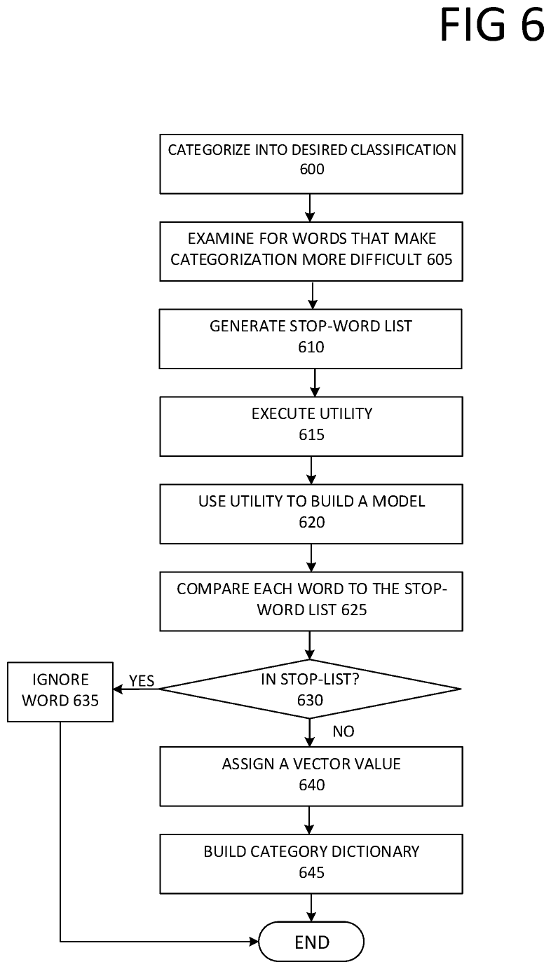

The categorization can use the “liblinear” library made available by the Machine Learning Group at National Taiwan University. Liblinear is a library used for large linear classification using logistic regression and linear support vector machines. FIG. 6 is a flowchart that illustrates the operation of text categorization according to one embodiment of an instrument management system.

To provide classification of mail, a model can be built from existing mail. The first step in building the model involves separating ASCII text copies of mail into groups that represent the category desired in the classification at step 600. Next, the text documents are examined for common words that may make categorization more difficult at step 605. This examination results in a list of words that is added to a stop-word list at step 610. The stop-word list can contain commonly found words that are excluded from the categorization process.

Once the mail copies have been grouped, a utility is run at step 615 that takes the text documents and builds the model suitable for use by the utility at step 620. As the model is built, each word is compared against the stop-list as well as a standard language dictionary at step 625. At step 630 the process determines whether the word is present in the stop-list. If the word is in the stop-list, it is ignored at step 635. Otherwise, at step 640, each word is assigned a vector value which can be its index value in the list. All words in the group that are to be used in the model can be weighted by computing the TF-IDF value for each word in each document in order to build a unique category dictionary at step 645.

The result of the process of FIG. 5 is a word list that is made up of categories that have a list of mail that has a list of words with a frequency count. The dictionary is made up a list of words and the IDF value for that word across the wordlist. Calculation of the TF-IDF can be done, for example, using a TFIDF equation: (tfidf =(doc_word_inst_count/total_doc_words)*idf). This dictionary is then stored. The word list and the weighting can form the basis for other aspects of the invention, as herein described.

As the classifier is employed, it first loads the model, the stop-list and a standard word dictionary appropriate for the language configured for the OCR engine. When a piece of mail passed to the classifier, it first reduces the words within the document to only those not excluded by the stop-list, a standard word dictionary and the corpus dictionary. The index value of the word is extracted from the corpus dictionary and used to create a vector of other words from the piece of mail. The vector is then passed to the classifier to determine the best category from the model. The resulting value from the classification is a label that was used to specify the categories when the model was built. In practice, this label corresponds to the primary key of the category list stored in the database. The resulting category is then assigned to the piece of mail.

Rules Augmentation

The last step prior to creating an assignment record and making a piece of mail available for routing, can involve running the mail against a list of rules using a rules engine. Rules can be created in and stored in the database and allow different elements of the letter contents to be used in the evaluation. Rules have a set of conditions and a set of actions associated with them. When all conditions are met, all of the actions are performed. Since the rules engine can be naive, the rules are executed in a configurable order and unless a break action is specified, all rules are run against each piece of mail. Additionally, in the embodiment that uses a naive rule engine, there is no forward or backward chaining so that actions which change evaluated fields do not cause previously fired rules to be reactivated.

The fields that are available for evaluation are those that are the result of processing piece of mail. The following information from the mail can be used in simple conditional statements. These conditional statements mainly allow for a simple equality comparison against predefined values or no value. Examples include, but are not limited to the letter category, the employee assigned to the letter, the sender identified as having sent the letter, text that appears in the letter, text that appears on the envelope, a flag indicating the mail was to be routed, what company address was identified with the receiver, text that appeared in the receiver text block, and text that appeared in the sender text block.

When all conditions of a rule evaluate to true, then the actions associated with the rule are performed. The actions for a can include, but are not limited to, a break from further rule evaluations against this piece of mail, a set the sender for the piece of mail, a set the receiver for the piece of mail, and a schedule the piece of mail to be routed to the receiver of the mail.

Mail Routing

A routing block, such as block 260 of FIG. 2 is now discussed in more detail. The routing block 260 can be responsible for delivering information to a user or employee. In most cases the mail is routed to the employee the mail is assigned to. In some cases, however, the employee has a rule set up to have the original or a copy of the mail routed to another employee.

Routing to an employee involves retrieving the assignment record, duplicating it as a mail record and removing the original assignment record. In all instances, the original images the assignment records point to are not copied, according to one embodiment. Instead, additional references to the images are created.

Once a piece of mail has been assigned to an employee and is ready for routing, it is marked as ready for routing using a flag. At this point, the assignment of the mail may have been done by automatic identification or manual assignment and the record can be queried for which employee it is for. If the employee has a “forward” flag set, then the forwarding information is read. Forwarding may involve either routing it only to the forwarded employee or to route it to the forwarded employee as well as provide a copy of the mail to the employee who was indicated as the original recipient.

E-Mail Notification

A notification block, such as block 130 of FIG. 1 is now discussed in more detail. When new mail arrives for an employee, the system sends the employee mail either on a daily or piece-wise basis. The email sent is a message set by the administrator to the email address registered with the employee record. If the notification is due to a piece-wise delivery, then a link to an image of the envelope can also be included in the email. Once a notification is sent, the employee's mail is updated to show that the notification for the mail was sent.

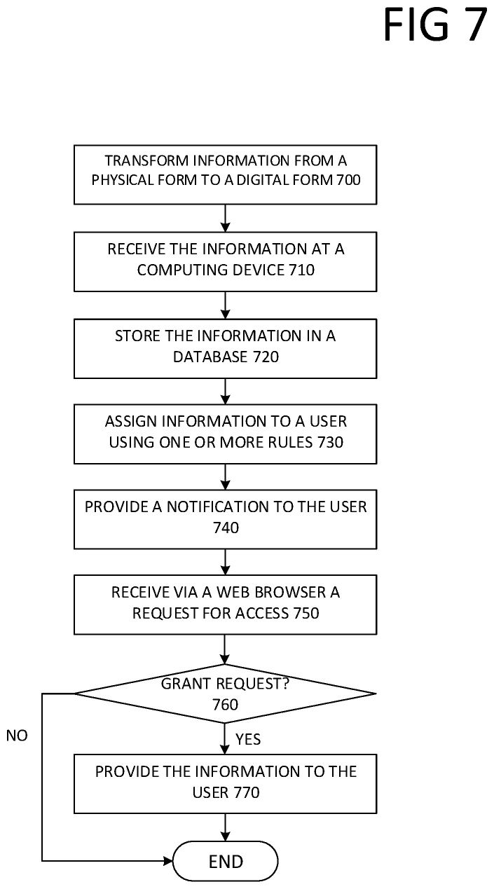

One embodiment of the present invention is shown with respect to FIG. 7. FIG. 7 is a flowchart that illustrates the operation of one embodiment of an instrument management system. At step 700, information is transformed into a digital form from a physical form. At step 710, the information is received at a computing device, such as a server or other computer. At step 720, the information is stored it in a storage medium which is capable of interacting with a database. At step 730, one or more rules are assigned to the information. At step 740, a notification is provided to the user. This can be in the form of an e-mail, for example.

At step 750, a request is received for access to the information. This could come, for example, via a conventional web browser using HTTP. At step 760, the system determines whether it can grant the request. If it cannot, the request is denied, and the process ends. Otherwise, the request is granted, and the information is provided to the user at step 770.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An information management system comprising:
a first system for transforming the information into a digital form;
a second system for receiving the information from the first system, the second system comprising, a receiving system for receiving the information and storing it in a storage medium; an assignment system for accessing the information from the medium and assigning it to a user based on one or more rules, and a routing system for delivering the information to the user.

2. The information management system of claim 1, wherein the first system further includes a forwarding system for sending the information to the second system.

3. The information management system of claim 1 further comprising a database communicatively coupled to the first and the second systems.

4. The information management system of claim 3, wherein the first system stores the information in the database.

5. The information management system of claim 3, wherein the second system accesses one or more rules associated with the information.

6. The information management system of claim 5, wherein the second system uses the rules to determine a user to associate with the information.

7. The information management system of claim 1, further comprising a notification system for providing a notification to the user associated with the information.

8. A method comprising:
transforming information from a physical form to a digital form;
receiving the information at a computing device and storing the information in a database;
applying one or more rules to the database to assign the information to a user;
providing a notification to the user associated with the information;
receiving via a web browser a request to access the information; and
determining if the request to access can be granted, and if so providing the information to the user.

9. The method of claim 8, further comprising forwarding the information to the second system.

10. The method of claim 8, further communicatively coupling a database to the first and the second systems.

11. The method of claim 10, further comprising storing the information in the database.

12. The method of claim 10, further comprising accessing one or more rules with the second system, wherein the one or more rules are associated with the information.

13. The method of claim 12, further comprising using rules by the second system, wherein the rules determine a user to associate with the information.

14. The method of claim 8, further comprising providing a notification to the user associated with the information.

15. A device comprising:
a transformation module configured to transform information from a physical form to a digital form;
a receiving module configured to receive the information at a computing device and store the information in a database;
an assignment module configured to use the database to assign the information to a user;
a notification module configured to provide a notification to the user associated with the information; and
an access control module configured to receive via a web browser a request to access the information, wherein when the access control module can grant the request, the information is provided to the user.

16. The device of claim 15, further comprising a forwarding module configured to forward the information to the receiving module.

17. The device of claim 15, further a communicatively coupling between the database, the forwarding module and the receiving module.

18. The device of claim 17, further comprising one or more rules configured to be associated with the information in the database

19. The device of claim 17, further comprising a notification module configured to provide a notification to the user associated with the information.

20. The device of claim 19, wherein the notification is provided when the notification module uses an email system module.
